(19) United States
(12) Patent Application Publication
(10) Pub. No.: US 2026/0086042 A1
(43) Pub. Date: Mar. 26, 2026

(54) DEFECT DETECTION DEVICES AND METHOD FOR DETECTING DEFECTS

(71) Applicant: Samsung Electronics Co., Ltd., Suwon-si (KR)

(72) Inventors: Jiho Park, Suwon-si (KR); Hyenok Park, Suwon-si (KR); Jong Chul Kim, Suwon-si (KR); Younghoon Sohn, Suwon-si (KR); Hyung Keun Yoo, Suwon-si (KR); Yongdeok Jeong, Suwon-si (KR)

(21) Appl. No.: 19/265,388

(22) Filed: Jul. 10, 2025

(30) Foreign Application Priority Data
Sep. 26, 2024 (KR) 10-2024-0131176

(51) Int. Cl. G01N 21/956; G01N 21/17; G01N 21/41

(52) U.S. Cl. CPC G01N 21/95607; G01N 21/41; G01N 2021/1765

(57) ABSTRACT

A defect detection method according to an embodiment includes: performing a zero padding on a defect image and a reference image having the same focus offset as the defect image; converting the defect image and the reference image into a defect phase image and a reference phase image, respectively, using a phase enhanced algorithm; generating a phase enhanced image based on the defect phase image and the reference phase image; and detecting a defective signal from the phase enhanced image.

### CROSS-REFERENCE TO RELATED APPLICATION

This application claims priority to and the benefit of, under 35 U.S.C. § 119, Korean Patent Application No. 10-2024-0131176 filed in the Korean Intellectual Property Office on Sep. 26, 2024, the entire contents of which are incorporated herein by reference.

### BACKGROUND

The present disclosure relates generally to a defect detection device and a defect detection method for detecting defects in a die.

Micro-integrated circuits including micro-electro-mechanical systems (MEMS), mobile application processor (AP), dynamic random access memory (DRAM), and flash memory utilizing a semiconductor microfabrication technology are attracting attention as they integrate various functions in fields of mechanics, electronics, optics, and chemistry. Devices including the MEMS or the micro-integrated circuits are used in a variety of fields, including vehicles, medical sensors, inkjet printer heads, reflective projectors, and chips for bio-analysis. However, devices including the MEMS or the micro-integrated circuits are composed of very fine structures, so an inspection for defects such as foreign substances or scratches is important during the manufacturing process thereof. Previously, an inspection method that utilized differences in brightness intensity was mainly used, but this method reached a small defect detection limit.

### SUMMARY

An embodiment of the present inventive concept provides a defect detection device and a defect detection method capable of effectively detecting a weak defective signal.

An embodiment of the present inventive concept provides a defect detection device and a detection method capable of quickly identifying a defect.

A defect detection method according to an embodiment to solve these and other technical objects may include performing a zero padding on a defect image and a reference image having the same focus offset as the defect image; converting the defect image and the reference image into a defect phase image and a reference phase image, respectively, using a phase enhanced algorithm; generating a phase enhanced image based on the defect phase image and the reference phase image; and detecting a defective signal from the phase enhanced image.

A defect detection device according to an embodiment may include: a light source illuminating a wafer including a plurality of dies; a camera capturing at least one of the plurality of dies; and an electronic device configured to set up a recipe that includes at least one of a pixel size, a wavelength, an aperture, a polarization, or a scan speed, to control the camera and the light source to capture the die based on the recipe, to receive information about a defect image and a reference image of the die from the camera, to convert the defect image and the reference image into a defect phase image and a reference phase image, respectively, through a phase enhanced algorithm, to generate a phase enhanced image based on the defect phase image and the reference phase image, and to control the camera and the light source to capture another one of the plurality of dies based on the recipe if a defective signal is detected in the phase enhanced image.

A defect detection device according to an embodiment may include a storage device that stores a defect image and a reference image; an electronic device performing a zero padding on the defect image and the reference image that has the same focus offset as the defect image, and converting the defect image and the reference image into a defect phase image and a reference phase image, respectively, using a phase enhanced algorithm; and a camera that captures images of a die by adjusting a focus offset of a lens.

### BRIEF DESCRIPTION OF THE DRAWINGS

The above and other aspects and features of the present disclosure will become more apparent by describing in detail example embodiments thereof with reference to the attached drawings, wherein like reference numerals (when used) indicate corresponding elements throughout the several views, and in which:

FIG. 1 is a schematic block diagram showing a defect detection device according to an embodiment;

FIG. 2 is a block diagram showing a configuration of an electronic device of FIG. 1;

FIG. 3 is a schematic top view of a wafer;

FIG. 4 is a flowchart showing an example defect detection method according to an embodiment;

FIG. 5 to FIG. 9 are views showing patch images of a die scanned by a camera in the illustrative defect detection device of FIG. 1 at various focal points;

FIG. 10 and FIG. 11 are views showing a delta (i.e., difference) image generated based on a difference between a reference image and a patch image according to an embodiment;

FIG. 12 is a view showing a differential image generated based on a difference between delta images generated based on different focal points according to an embodiment;

FIG. 13 and FIG. 14 are views showing a delta image generated based on a difference between a reference image and a patch image according to a comparative example;

FIG. 15 is a view showing a differential image generated based on a difference between delta images generated based on different focal points according to a comparative example;

FIG. 16 is a flowchart showing example steps of detecting a defective signal using a phase enhanced algorithm of a defect detection method according to an embodiment;

FIG. 17 is a view showing a first patch image with a zero padding performed;

FIG. 18 is a view showing a reference image of a first patch image with a zero padding performed;

FIG. 19 is a view showing a second patch image with a zero padding performed;

FIG. 21 is a flowchart showing a step for generating a phase enhanced image of a defect detection method according to an embodiment;

FIG. 22 is a first phase image showing a difference between patch phase images;

FIG. 23 is a view showing a second phase image showing a difference between reference phase images;

FIG. 24 is a view showing a phase enhanced image created by subtracting a second phase image from a first phase image;

FIG. 25 to FIG. 28 are views showing a phase enhanced image generated based on a phase enhanced algorithm;

FIG. 29 is a view showing a phase enhanced image generated by performing an optimization process of a phase value by 10,000 times in a phase enhanced algorithm according to a comparative example;

FIG. 30 is a view showing a phase enhanced image generated by performing an optimization process of a phase value by 20,000 times in a phase enhanced algorithm according to a comparative example;

FIG. 31 is a view showing a phase enhanced image generated by performing an optimization process of a phase value by 30,000 times in a phase enhanced algorithm according to a comparative example;

FIG. 32 to FIG. 34 are views showing an image in which an electron beam inspection is performed to detect defects in a die (e.g., 31 of FIG. 3) after a pattern is formed on a wafer; and

FIG. 35 is an example block diagram showing a computer device according to an embodiment.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. In flowcharts described with reference to the drawings, the order of operations or steps may be changed, several operations or steps may be merged, a certain operation or step may be divided, and/or a specific operation or step may not be performed.

In the description, expressions described in the singular in this specification may be interpreted as the singular or plural unless an explicit expression such as “one” or “single” is used. An expression such as “first” and “second” indicate various constituent elements regardless of order and/or importance, is used for distinguishing a constituent element from another constituent element, and does not limit corresponding constituent elements. These terms may be used to distinguish one component from another.

Hereinafter, the present disclosure will be explained in more detail through examples. These examples are intended only to illustrate the present disclosure, and a scope of the present disclosure is not intended to be limited in any way by these examples.

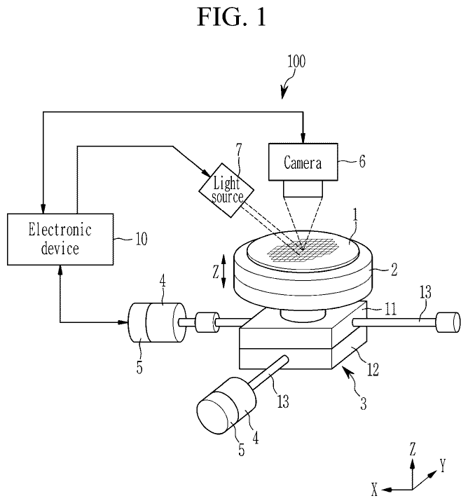

FIG. 1 is a schematic block diagram showing a defect detection device according to an embodiment.

Referring to FIG. 1, a defect detection device 100, for example, may include a wafer table 2 for holding a semiconductor wafer 1 (hereinafter, simply referred to as a wafer 1) of a silicon material, an XYZ stage 3 to selectively move the corresponding wafer table 2 in an X direction, a Y direction, and/or a Z direction, a camera 6 configured for capturing images of the wafer 1 from above, a light source 7 configured to illuminate the wafer 1 during imaging by the camera 6, and an electronic device 10 configured to control an operation of each of these parts and also perform an image processing described below.

The wafer 1 may be fixed to the wafer table 2, for example by adsorption using an adsorption means such as a vacuum pump. When processes such as lithography, etching, doping, and deposition are performed on the wafer 1, the wafer table 2 may position and fix the wafer 1 in a precise position. The wafer 1 may be separated into a plurality of dies through a dicing process. The defect detection device 100 may detect defects such as foreign substances or scratches on the die by using the die as an inspection target.

The camera 6 may receive a trigger signal output from the electronic device 10. The camera 6 may be fixed at a predetermined position above the wafer 1 and may capture the images of the die based on the trigger signal. The camera 6 may have a built-in lens and shutter. The camera 6 may capture the image of the die magnified by the built-in lens. The camera 6 may transmit the image of the captured die to the electronic device 10.

The camera 6 may precisely adjust the focal point by utilizing an automatic focal point (AF) technology when capturing the images of the wafer 1. As part of performing the automatic focal point technology, the camera 6 may be configured to trigger a laser to measure the distance to the surface of the wafer 1 and then adjust the lens position to align the focal point. Additionally, the height change of the wafer 1 surface can be measured using the phase difference, and the focal point of the lens may be adjusted based on this.

The XYZ stage 3 may adjust the relative distance between the camera 6 and the wafer 1 by moving the wafer 1 in the vertical direction (the Z direction).

The XYZ stage 3 may include a motor 4 and an encoder 5. The motor 4 may be connected to a movement shaft 13, so that the X stage 11 and the Y stage 12 may move in the X direction, the Y direction, and the Z direction respectively. The encoder 5 is a sensor that measures the position information of the X stage 11 and the Y stage 12 and may be connected to the motor 4. The encoder 5 generates an encoder signal, which is the movement information (a coordinate information), whenever the X stage 11 and the Y stage 12 move by a unit distance in the X, Y, and Z directions, and outputs the encoder signal to the electronic device 10. Additionally or alternatively, the encoder 5 may accurately measure the position of the movement shaft 13 to determine the movement distance of the X stage 11 and the Y stage 12.

The light source 7 may be fixed at a predetermined position above the wafer 1. The light source 7 may include a flash lamp made of a white LED or a xenon lamp of a high luminance, and a flash lighting circuit that controls the lighting of the flash lamp, and may also include a laser light source. At this time, the laser light source may emit light of specific wavelengths, such as, but not limited to, 193 nanometers (nm), 266 nm, 450 nm, and 532 nm, when a high resolution precision illumination is required. The light source 7 may illuminate the wafer 1 based on the flash signal output from the electronic device 10.

The electronic device 10 may receive the encoder signal as the input from the encoder 5. The electronic device 10 may output the flash signal to the light source 7 and the trigger signal to the camera 6 based on the encoder signal. Additionally, the electronic device 10 may output a motor control signal to the motor 4 that controls the operation of the motor 4 based on the encoder signal.

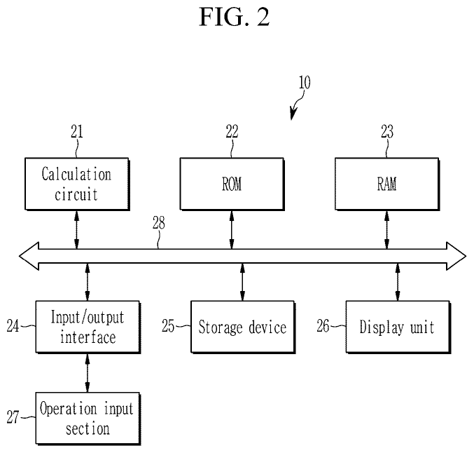

FIG. 2 is a block diagram showing a configuration of an electronic device of FIG. 1, according to one or more embodiments.

Referring to FIG. 2, the electronic device 10 may include a calculation circuit (e.g., a central processing unit) 21, a read only memory (ROM) 22, a random access memory (RAM) 23, an input/output interface 24, a storage device 25, a display unit 26, and an operation input section 27, and these parts may be electrically connected to each other via an internal bus 28.

The calculation circuit 21 comprehensively controls each part of the electronic device 10 and may perform various operations in an image processing and an operation process of the phase enhanced algorithm described below.

The ROM 22 is a non-volatile memory that may store programs required to start up the electronic device 10 and other programs or data that do not need to be updated. The RAM 23 is a volatile memory that is used as a work region of the calculation circuit 21 and may temporarily store various data or programs by reading them from the storage device 25 or the ROM 22.

The input/output interface 24 is an interface for connecting the operation input section 27 or the motor 4, the encoder 5, the light source 7, and the camera 6 (see FIG. 1) to the internal bus 28, and for the input of the operation input signal from the operation input section 27 and the exchange of various signals with the motor 4, the encoder 5, the light source 7, and the camera 6.

The storage device 25 may store various programs for performing an operating system (OS), or an imaging processing and an image processing described below, other various applications, an image data such as the image of the die as the inspection target image captured by the camera 6 and a model image (described later) created from the inspection target image, or various data for reference in the imaging processing and the image processing, etc. in a built-in hard disk.

The display unit 26 displays the images captured by the camera 6 or various condition screens for the image processing.

The operation input section 27 may include, for example, a keyboard or mouse, and inputs operations from the user in the image processing, etc., which will be described later.

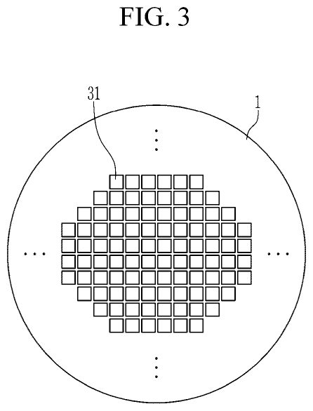

FIG. 3 is a schematic top plan view of a wafer suitable for use with the illustrative defect detection device 100 of FIG. 1.

Referring to FIG. 3, the wafer 1 may include a plurality of dies 31. Each die 31 is a basic unit that forms individual semiconductor devices within the wafer 1. The plurality of dies 31 may be arranged in a grid shape pattern on the wafer 1 surface. For example, the 96 dies 31 may be formed in the grid shape on the wafer 1 surface. The number of dies 31 on the wafer 1 is not limited to any specific number.

A defect may occur in the die 31 during the manufacturing process of the wafer 1. For example, surface defects such as scratches, particles, contamination, pinholes, and/or cracks may occur. Electrical defects such as an open circuit, a short circuit, a leakage current, and an impedance defect may occur. Process defects such as an under-etching, an over-etching, a defective doping, and a defective deposition may occur. The defects of the die 31 are not limited to this. However, for better understanding and ease of explanation, the explanation herein focuses on a top loss defect, which is a defect caused by physical damage occurring at the upper surface of the die 31. For example, a top loss defect may occur when a cap of a contact connecting a transistor and a wiring becomes separated. If the cap of the contact is separated, a signal transmission between the transistor and the wiring is interrupted or weakened, and the connection part between the transistor and the wiring may be directly exposed to an external impact, which may damage the surface of the die 31.

The defect detection device (100 in FIG. 1) may detect the top loss defect of the die 31. The defect detection device 100 may detect an irregular pattern of the die 31 on the wafer 1 surface through an optical inspection. Since the defect detection device 100 may identify the defects in the die 31 before a dicing is performed, the defects in the die 31 may be detected quickly.

In some embodiments, the defect detection device 100 may perform the optical inspection on the die 31 cut by a die cutting (i.e., dicing). In this case, the inspection conditions may be optimized for the individual die 31, which may improve a defect detection accuracy.

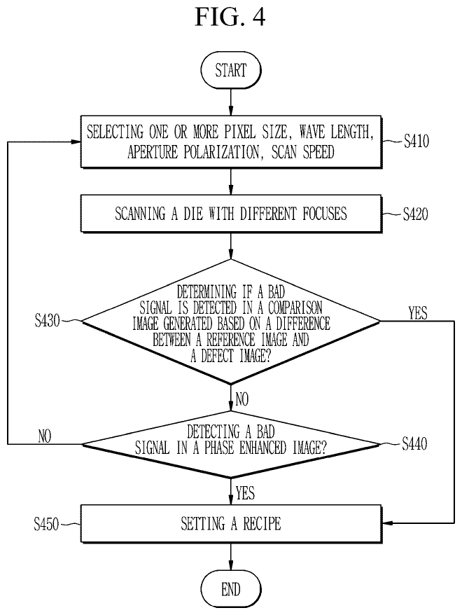

FIG. 4 is a flowchart showing an example defect detection method according to an embodiment.

In a step (S410), the defect detection device (100 of FIG. 1) may set at least one of a pixel size, a wavelength, an aperture, a polarization, or a scan speed.

The pixel size, which is the size of the image created by capturing one of the plurality of dies (31 in FIG. 3) with the camera (6 in FIG. 1), is related to a resolution. The pixel size may affect the resolution of the image. The larger the pixel size, the lower the image resolution (i.e., less total pixels per image), and the smaller the pixel size, the higher the image resolution (i.e., more total pixels per image). However, since the smaller pixel size may result in a poor performance and higher noise in low-light environments, the electronic device 10 may determine the pixel size by considering the resolution and the image quality. For better understanding and ease of explanation, the following description assumes a pixel size of 250 nm.

The light source 7 may irradiate light of a specific wavelength onto the surface of the wafer (FIG. 3, 1) based on the flash signal output from the electronic device 10 (see FIG. 1). The wavelength of light irradiated by the light source 7 onto the wafer 1 surface may be determined based on the size of the defective region included in the die 31. As the size of the defective region becomes smaller, the light source 7 may irradiate a shorter wavelength onto the wafer 1 surface. For better understanding and ease of explanation, the following description assumes that the wavelength of the light irradiated by the light source 7 to the wafer 1 surface is 190 nm-240 nm.

The camera 6 may be equipped with an aperture to control the amount of light reaching the inside of the lens. The camera 6 may control the amount of light reflected from the wafer 1 through the aperture. The aperture may be positioned in the lens of the camera 6. As the aperture of the camera, a variable illumination bright field (VIB) aperture, a bright field (B) aperture, and an edge contrast plus (ECP) aperture may be used. However, this is only an example. For better understanding and ease of explanation, the following description assumes that the aperture mounted on the camera 6 is an ECP aperture.

The camera 6 may align the light reflected from the wafer 1 in the horizontal or vertical direction using a polarization filter. The polarization filter may be attached on the lens. By using a polarization filter, a scattering of light reflected from the wafer 1 surface may be prevented. The camera 6 may align the light reflected from the wafer 1 in the horizontal direction through the horizontal-normal (HN) polarization filter. The camera 6 may align the light reflected from the wafer 1 in the vertical direction through the normal-normal (NN) polarization filter. For better understanding and ease of explanation, the following description assumes that the polarization filter attached to the lens is the NN polarization filter.

The camera 6 may receive a trigger signal including a scan speed or a shutter speed from the electronic device 10. At this time, the scan speed or the shutter speed may be determined based on the flash signal that the electronic device 10 outputs to the light source 7. The camera 6 may collect the light reflected from the wafer 1 for a certain time based on the scan speed or the shutter speed. The higher the scan speed or shutter speed, the more light the camera 6 may collect. For better understanding and ease of explanation, the following description assumes that the scan speed of the camera 6 is ⅜ (0.375 seconds).

In a step (S420), the defect detection device 100 may scan the die (31 of FIG. 3) at multiple focal points. The camera 6 may image the wafer 1 at multiple focal distances. The camera 6 may acquire a captured image corresponding to a plurality of focus offsets. With the die 31 as a reference, the focus offset for the focal distance closer to the camera 6 in the upward direction Z may be larger than the focus offset for the focal distance farther from the camera 6 in the upward direction Z. The focus offset may mean the difference from the focal distance that serves as the reference for the shooting.

In some embodiments, an upper layer may be deposited on a lower layer of wafer 1 including a noise region. In this case, the noise region may be detected by subtracting the image scanning the lower layer of wafer 1 from the image scanning the upper layer of the wafer 1. Additionally, the process of detecting the noise region of the lower layer of the wafer 1 may be stopped until the upper layer of the wafer 1 is stacked.

In addition, in the defect detection method that subtracts the image scanned of the lower layer of the wafer 1 from the image scanned of the upper layer of the wafer 1, a scan of an intermediate layer of the wafer 1, which is stacked between the upper layer of the wafer 1 and the lower layer of the wafer 1, may be performed. For example, the wafer 1 may include 30-40 intermediate layers. In this case, in order to detect the top loss defects, the images for at least 30-40 intermediate layers must be stored, which may result in unnecessarily excessive storage capacity. However, the defect detection device 100 according to the embodiments may detect the defect in the die 31 by scanning only the wafer 1, which is the defect detection target, and the wafer 1 that does not include the defective region. The method for detecting the defects in the die 31 is explained in detail through the drawings below.

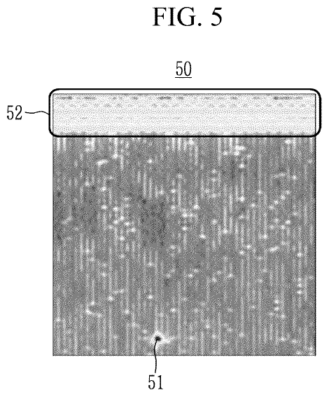

FIG. 5 to FIG. 9 are views showing patch images of a die scanned by a camera of FIG. 1 at multiple focal points, according to embodiments of the present disclosure.

Before explaining FIG. 5 to FIG. 9, the meaning of patch images 50, 60, 70, 80, and 90 is as follows. The camera 6 may receive light reflected from the wafer (FIG. 3, 1), to be converted into an electric signal, and generate a digital image data of the wafer 1 based on the electric signal. The camera 6 may segment the digital image data of the wafer 1 using the size of the die 31 as a reference to detect the defects within the die (31 in FIG. 3). At this time, the plurality of divided image data may mean the patch images 50, 60, 70, 80, and 90.

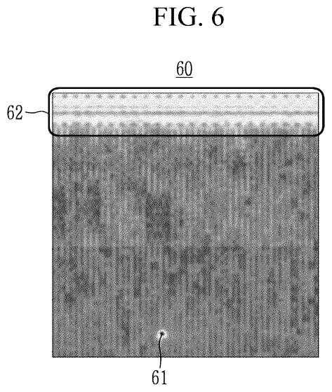

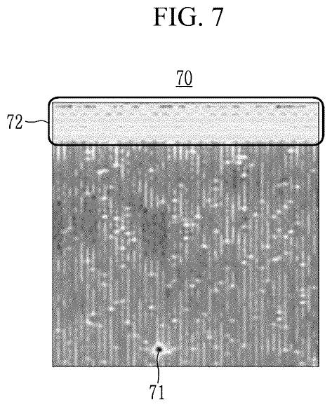

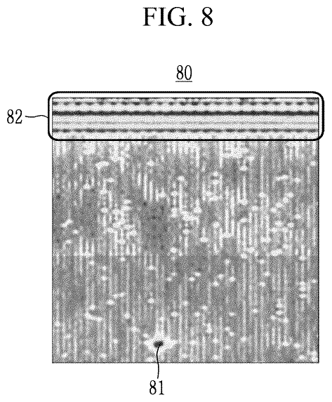

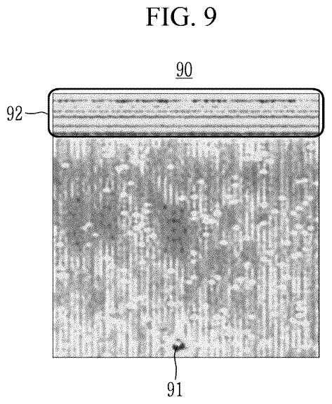

Referring to FIG. 5 to FIG. 9, the camera 6 (see FIG. 1) may generate the patch images 50, 60, 70, 80, and 90, respectively, based on the light reflected from the wafer 1. The camera 6 images the wafer 1 with the plurality of focal distances, and accordingly, the focus offsets of each of the patch images 50, 60, 70, 80, and 90 of FIG. 5 to FIG. 9 may be different. FIG. 5 shows the patch image 50 with the focus offset of −0.1, and FIG. 6 shows the patch image 60 with the focus offset of 0.0. FIG. 7 shows the patch image 70 with the focus offset of 0.1, FIG. 8 shows the patch image 80 with the focus offset of 0.15, and FIG. 9 shows the patch image 90 with the focus offset of 0.2.

Each of the patch images 50, 60, 70, 80, and 90 of FIG. 5 to FIG. 9 may be a patch image including the defective region in the die 31 (hereinafter referred to as a defect image) or a patch image not including the defective region in the die 31 (hereinafter referred to as a reference image). The following explanation assumes that the patch images 50, 60, 70, 80, and 90 in FIG. 5 to FIG. 9 are the defect images including the defective regions.

In some embodiments, the dies 31 may already be determined as defective through an electron beam inspection. The defect detection device (100 in FIG. 1) may photograph (or otherwise capture and store an image of) the dies 31 determined to be defective and generate the defect images 50, 60, 70, 80, and 90. Similarly, the defect detection device 100 may photograph the die 31, which has already been determined to be normal through an electron beam inspection, and create a reference image.

Each of the defect images 50, 60, 70, 80, and 90 of FIG. 5 to FIG. 9 may include burn marks 51, 61, 71, 81, and 91 and noise regions 52, 62, 72, 82, and 92, respectively. The positions of the defective regions to be detected in the defect images 50, 60, 70, 80, and 90 may be roughly identified through the burn marks 51, 61, 71, 81, and 91. The burn marks 51, 61, 71, 81, and 91 may be positioned by a predetermined distance away from the defective region where the defect is detected. For example, a scanning electron microscope (SEM) may detect the defects within the die 31 through the electron beam inspection and create the burn marks 51, 61, 71, 81, and 91 in regions adjacent to the defective region. The burn marks 51, 61, 71, 81, and 91 may be positioned, for example, 3 nm downstream from the defective region. The burn marks 51, 61, 71, 81, and 91 may be generated by a physical deformation of the surface of the die 31 (e.g., by laser or other means) as observed by the SEM. The noise region 52, 62, 72, 82, and 92 may include a gray-level (GL) noise with abrupt changes in brightness or color values of the defect images 50, 60, 70, 80, and 90, and irregular and large pattern noise.

In a step (S430) in the example method of FIG. 4, the defect detection device 100 may generate a comparison image based on the difference between the reference image and the defect images 50, 60, 70, 80, and 90 for each focal point, and determine whether a defective signal is detected in the comparison image, the defective signal being indicative of a defect present in the die under observation (e.g., die 31 in FIG. 3). The defect detection device 100 may align the position, size, and angle between the reference image and the defect images 50, 60, 70, 80, and 90 for each focal point, and calculate the difference in pixel values between the reference image and the defect images 50, 60, 70, 80, and 90 for each focal point. The defect detection device 100 may generate the comparison image based on the difference in the pixel values.

The comparison image may include a delta image and a differential image. The delta image may refer to the comparison image generated based on the differences between the reference image and the defect images 50, 60, 70, 80, and 90 of the same focal point. The differential image may mean the comparison image generated based on the difference between the delta images generated based on the different focal points.

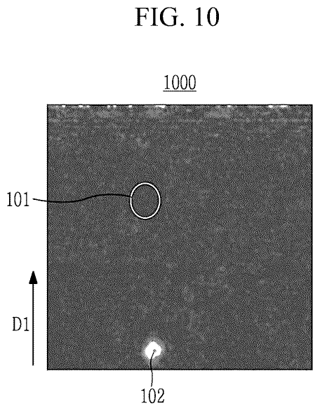

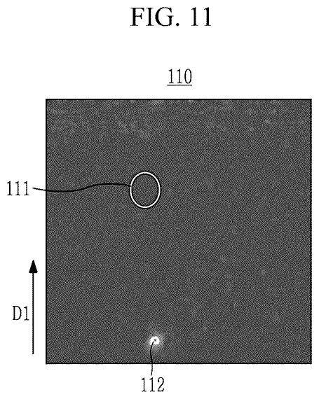

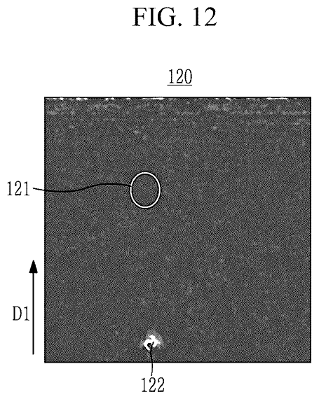

FIG. 10 and FIG. 11 are views showing a delta image generated based on a difference between a reference image and a patch image according to an embodiment.

Referring to FIG. 10, the first delta image 1000 may be generated based on the difference between the reference image and the defect image (80 in FIG. 8) at the focus offset of 0.15. In the first delta image 1000, the defective signal 101 is not detected, and only the burn mark 102 for identifying the position of the defective signal 101 may be detected.

Referring to FIG. 11, the second delta image 110 may be generated based on the difference between the reference image at the focus offset of −0.1 and the defect image (50 in FIG. 5). Even in the second delta image 110, the defective signal 111 may be not detected, and only the burn mark 112 for identifying the position of the defective signal 111 may be detected.

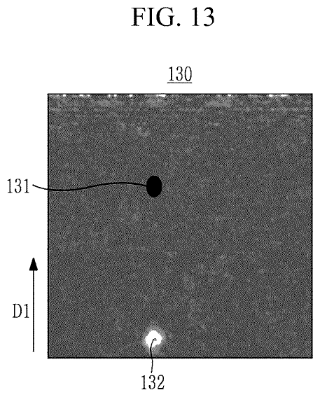

FIG. 12 is a view showing a differential image generated based on a difference between delta images generated based on different focal points according to an embodiment.

Referring to FIG. 12, the differential image 120 may be generated based on the difference between the first delta image (1000 in FIG. 10) at the focus offset 0.15 and the second delta image (110 in FIG. 11) at the focus offset −0.10. Even in the differential image 120, the defective signal 121 may be not detected, and only the burn mark 122 for identifying the position of the defective signal 121 may be detected.

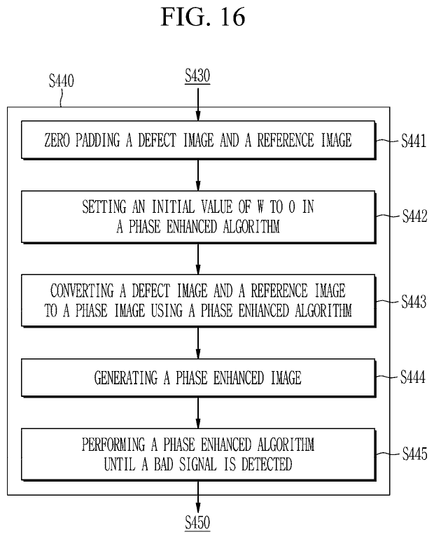

Referring again to FIG. 4, if the defective signal is not detected in the comparison image of the step (S430), the defect detection device 100 may detect the defective signal using a phase enhanced algorithm in step (S440). This is explained in more detail in conjunction with FIG. 16.

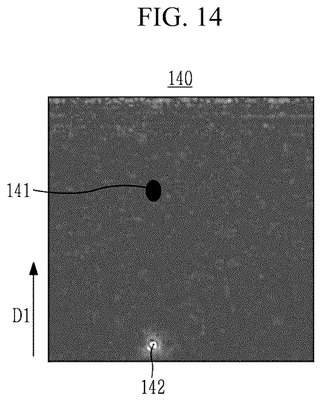

FIG. 13 and FIG. 14 are views showing a delta image generated based on a difference between a reference image and a defect image according to a comparative example.

Referring to FIG. 13, the first delta image 130 may be generated based on the difference between the reference image and the defect image (80 in FIG. 8) at the focus offset of 0.15. In the first delta image 130, the defective signal 131 can be detected in the first direction D1 with the burn mark 132 as a reference.

Referring to FIG. 14, the second delta image 140 may be generated based on the difference between the reference image at the focus offset of −0.1 and the defect image (50 in FIG. 5). In the second delta image 140, the defective signal 141 may be detected in the first direction D1 with the burn mark 142 as a reference.

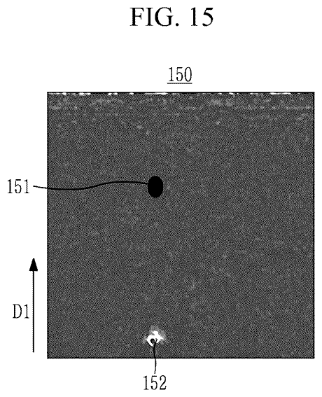

FIG. 15 is a view showing a differential image generated based on a difference between delta images generated based on different focal points according to a comparative example.

Referring to FIG. 15, the differential image 150 may be generated based on the difference between the first delta image (130 in FIG. 13) at the focus offset 0.15 and the second delta image (140 in FIG. 14) at the focus offset −0.1. In the differential image 150, the defective signal 151 may also be detected in the first direction D1 using the burn mark 152 as a reference.

Referring to FIG. 4, at the step (S430), if the defective signal is detected in the comparison image generated by the defect detection device 100, at step (S450), the defect detection device 100 may generate configuration settings. That is, if the defective signal is detected in the step (S430), the defect detection device 100 may skip the step (S440) and generate configuration settings based on, for example, the pixel size, wavelength, aperture, polarization, and scan speed set in the step (S413). The configuration settings may include parameters such as, but not limited to, the pixel size, wavelength, aperture, polarization, and scan speed that the defect detection device 100 sets to detect the defects in the die (31 in FIG. 3).

FIG. 16 is a flowchart showing an example method which may be performed by step S440 of FIG. 4 for detecting a defective signal using a phase enhanced algorithm of a defect detection method according to an embodiment.

In the step (S441), the defect detection device 100 may perform a zero padding on the defect images 50, 60, 70, 80, and 90 and the reference image. In the context of defect detection, the term “zero padding” generally refers to a technique of adding zeros around edges of an image or signal data before processing the image, thereby creating a border of zeros, which helps to prevent information loss at the image boundaries when applying filters or analysis methods such as, but not limited to, convolution, particularly when using machine learning models (e.g., convolutional neural networks (CNNs)) for defect detection. The defect detection device 100 may set the pixel values of the margin regions of the defect images 50, 60, 70, 80, and 90 and the reference image as 0. At this time, the margin region may be positioned on the edge region of the defect images 50, 60, 70, 80, and 90 and the reference image. The defect detection device 100 may generate a phase enhanced image without considering the Neumann boundary condition in the phase enhanced algorithm by zero-padding the defect images 50, 60, 70, 80, and 90 and the reference image. This will be explained in detail through subsequent drawings. As will be known by those skilled in the art, the Neumann (or second-type) boundary condition, in the context of mathematics, is a type of boundary condition which, when imposed on an ordinary or a partial differential equation, specifies the values of the derivative applied at the boundary of the domain.

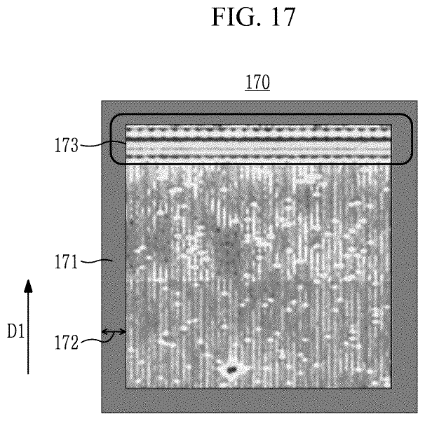

FIG. 17 is a view showing a first defect image 170 with a zero padding performed.

Referring to FIG. 17, the first defect image 170 assumes that the focus offset is 0.15 and the zero padding is performed which may include a padding region 171 and a masking region 173. The edge of the first defect image 170 may include a padding region 171 on which the zero padding is performed by the defect detection device 100. For example, the padding region 171 may be positioned at a width of a predetermined distance 172 from the edge of first defect image 170.

The first defect image 170 may include noises such as a pattern noise and a GL noise. If the noise is included in the first defect image 170, the defect detection device 100 may incorrectly recognize a normal signal as a defective signal. Accordingly, the defect detection device 100 may remove the noise through a masking operation.

The masking region 173 may be defines as the region where the noise distributed within the first defect image 170 is masked. The masking region 173 may be placed on the top of the first defect image 170 in the Z (i.e., vertical) direction. The position of the masking region 173 is only an example.

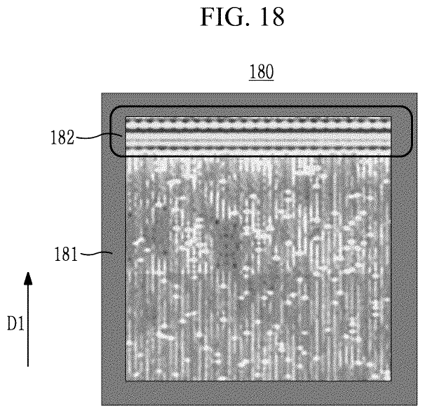

FIG. 18 is a view showing a reference image 180 with a zero padding performed.

Referring to FIG. 18, the reference image 180 with the focus offset of 0.15 and the performed zero padding may include a padding region 181 and a masking region 182. The description for the padding region 181 and the masking region 182 is the same as that for FIG. 17.

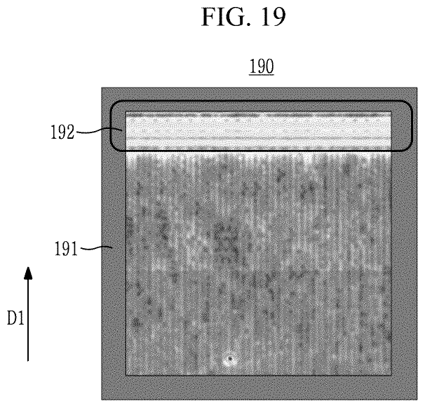

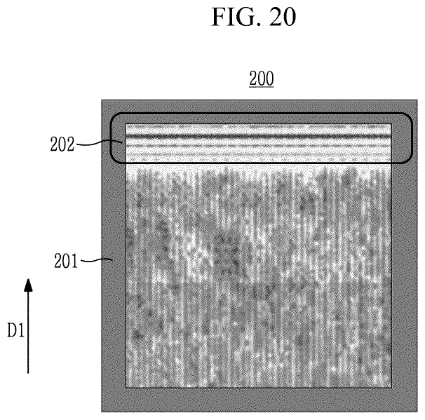

FIG. 19 is a view showing a second defect image 190 with a zero padding, and FIG. 20 is a reference image 200 with a zero padding.

Referring to FIG. 19, the second defect image 190 with the focus offset of −0.10 and the zero padding may include a padding region 191 and a masking region 192. Referring to FIG. 20, the reference image 200 with the focus offset −0.10 and the zero padding performed may include a padding region 201 and a masking region 202. The description for the padding region 201 and the masking region 202 is the same as that for FIG. 17.

Again referring to FIG. 16, in a step (S442), the defect detection device 100 may set the initial value of a parameter W of the phase enhanced algorithm to 0. The defect detection device 100 may convert the defect images 50, 60, 70, 80, and 90 (see FIGS. 5 through 9) and the reference image into defect phase images and a reference phase image, respectively, using the phase enhanced algorithm with the initial value of the parameter W set at 0. It may be the same as Equation 1 below of the phase enhanced algorithm.

W=argmin[|Δlz+Δ_{⊥}W|*α+|∂BS−0|*β+|BS−0|*γ] (Equation 1)

The phase enhanced algorithm may optimize the parameter W until the result value of the given Equation 1 reaches a minimum. Accordingly, Δ_{⊥}W becomes −Δlz, and the parameter W may be optimized until ∂BS=0, BS=0. At this time, the parameter W means the phase of the phase image.

Δlz may mean the difference value between the defect images 50, 60, 70, 80, and 90 with the different focal points. For example, Δlz may be calculated by subtracting the defect image with the focus offset of −0.1 (50 in FIG. 5) from the defect image with the focus offset of 0.15 (80 in FIG. 8). Additionally, Δlz may also mean the difference value between the reference images with the different focal points. For example, Δlz may be calculated by subtracting the reference image with the focus offset of −0.1 from the reference image with the focus offset of 0.15.

The parameter W is the phase of the phase image that includes the phase information of the defective signal. Δ_{⊥}W is a curvature of the phase change in the horizontal direction x and the vertical direction Y of the phase image generated through a convolution using a Laplacian filter. Δ_{⊥}W is an updatable parameter and may be updated to have the same size as the value of Δlz. α represents a weight value of |Δlz+Δ_{⊥}W| in given Equation 1.

|∂BS−0|*β+|BS−0|*γ is a Neumann boundary condition setting a change rate at the boundary of the phase image. ∂BS (Boundary Side) means the change rate of the edge value in the phase image, and BS means the edge value in the phase image. When there is a rapid change in the pixel value at the boundary of the phase image, the defect detection device 100 may control the change rate at the boundary of the phase image through the Neumann boundary condition. β means a weight value of |∂BS−0| in Equation 1, and γ means a weight value of |BS−0| in Equation 1.

If the initial value of the parameter W is set to 0, the value of the parameter W may be determined by considering only |Δlz+Δ_{⊥}W|*α, excluding the Neumann boundary condition in the phase enhanced algorithm. Accordingly, the convergence speed of the phase value through the phase enhanced algorithm may be accelerated by setting the initial value of parameter W to 0.

When the initial value of the parameter W starts from 0, the BS value, which is the value of the edge in the phase image, is 0, so |BS−0| may converge to 0. Also, since the BS value remains 0 at the edge, ∂|BS−0| may also converge to 0. Accordingly, B, the weight value of |BS−0|, and γ, the weight value of ∂|BS−0|, may be set to 0. Since only the operation for Δlz+Δ_{⊥}W|*α is performed excluding the Neumann boundary condition from the equation of the phase enhanced algorithm, the convergence of the parameter W value may be accelerated.

Again referring to FIG. 16, in a step (S443), the defect detection device 100 may convert the defect images (50, 60, 70, 80, and 90 of FIG. 5 to FIG. 9) and the reference image into each phase image using the phase enhanced algorithm with the initial value of the parameter W set at 0.

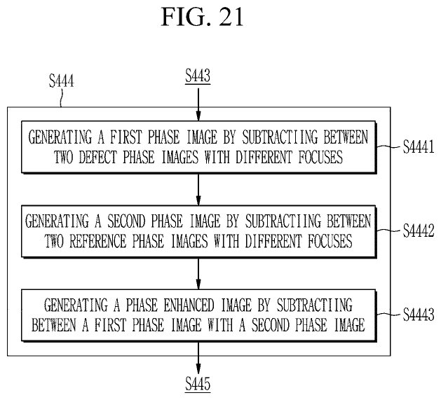

Again referring to FIG. 16, in a step (S444), the defect detection device 100 may generate a phase enhanced image based on the phase enhanced algorithm. At this time, if the initial value of the parameter W of the phase enhanced algorithm is predetermined as 0, the defect detection device 100 may generate an optimized phase enhanced image by subtracting the reference phase image from the defect phase image. The defect detection device 100 may detect the defective signal based on the optimized phase enhanced image. The process of generating the optimized phase enhanced image and detecting a defective signal from the optimized phase enhanced image are described in detail in FIG. 21 to FIG. 24.

FIG. 21 is a flowchart showing an example method which may be performed by step S444 in FIG. 16 for generating a phase enhanced image of a defect detection method, according to an embodiment.

In a step (S4441), the defect detection device 100 may generate a first phase image by subtracting two defect phase images having different focus offsets (i.e., focal points). At this time, the defect phase image may be a phase image for the defect image generated based on the phase enhanced algorithm with the initial value of 0 in the step (S443). For example, the defect detection device 100 may subtract the defect phase image with the focus offset of 0.15 from the defect phase image with the focus offset of −0.1. In this case, the defect detection device 100 may generate the first phase image by subtracting the defect phase image with the focus offset of −0.1 from the defect phase image with the focus offset of 0.15.

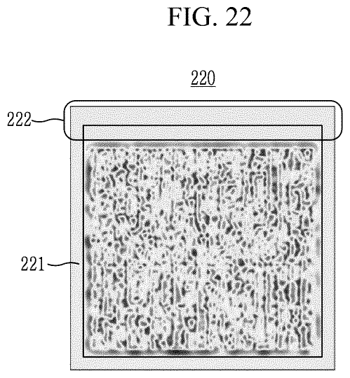

FIG. 22 is a view showing a first phase image 220 showing a difference between patch phase images.

Referring to FIG. 22, the first phase image 220 representing the difference between the patch phase images may include a padding region 221 and a masking region 222. At this time, in the step (S441), the padding region 221 generated by performing the zero padding on the edges of the defect images (50, 60, 70, 80, and 90 of FIG. 5 to FIG. 9) and the masking region 222 that masks the noise of the defect images 50, 60, 70, 80, and 90 may be maintained without being removed even in the step (S4441).

Again referring to FIG. 21, in a step (S4442), the defect detection device 100 may generate a second phase image by subtracting two reference phase images having different focus offsets. At this time, the reference phase image may be a phase image for the reference image generated based on the phase enhanced algorithm whose initial value is 0 in the step (S443) of FIG. 16. For example, the defect detection device 100 may subtract the reference phase image with the focus offset of 0.15 from the reference phase image with the focus offset of −0.1. In this case, the defect detection device 100 may generate the second phase image by subtracting the reference phase image with the focus offset of −0.1 from the reference phase image with the focus offset of 0.15.

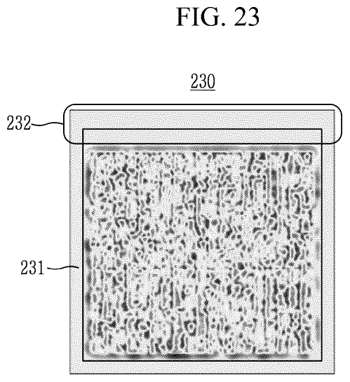

FIG. 23 is a view showing a second phase image 230 showing a difference between reference phase images.

Referring to FIG. 23, the second phase image 230 representing the difference between the reference phase image and the reference phase image may include a padding region 231 and a masking region 232. At this time, in the step S441, the padding region 231 generated by performing the zero padding on the edge of the reference image and the masking region 232 masking the noise of the reference image may be maintained without being removed even in the step (S4442).

Again referring to FIG. 21, in the step (S4443), the defect detection device 100 may generate a phase enhanced image by subtracting the second phase image (230 of FIG. 23) from the first phase image (220 of FIG. 22). In the phase enhanced image based on the difference between the defect images (50, 60, 70, 80, and 90 of FIG. 5 to FIG. 9) and the reference image, defective signals 101, 111, and 121 that were not detected in the first delta image (1000 of FIG. 10), the second delta image (110 of FIG. 11), and the differential image (120 of FIG. 12) may be detected.

The first delta image 1000 (see FIG. 10), second delta image 110 (see FIG. 11), and differential image 120 (see FIG. 12) may be generated based on the value Δl, which is the difference between the intensity of the light incident on the wafer (1 of FIG. 3) from the light source (7 of FIG. 1) and the intensity of the light reflected from the wafer 1. Also, when the wavelength λ of the light incident from the light source 7 is larger than the size d of the particle causing the defective signal of the die (31 in FIG. 3), the value Δl may be proportional to d⁴/λ⁶. At this time, as the difference between the wavelength (A) of the light and the size (d) of the particle increases, the value Δl decreases, and the defective signals 101, 111, and 121 may not be detected in the first delta image 1000, the second delta image 110, and the differential image 120.

The phase enhanced image may be generated based on the value ΔW, which is the difference between the phase of the light incident on the wafer 1 from the light source 7 and the phase reflected from the wafer 1. If the wavelength Δ of the light incident from the light source 7 is larger than the size d of the particle causing the defective signal of the die 31, the value ΔW may be proportional to the size d of the particle/the wavelength λ of the light. If the size d of the particle is the same but the wavelength λ of the light is longer, the value ΔW decreases, but the value ΔW may be higher than the value Δl. Accordingly, the defective signals 101, 111, and 121 that were not detected in the first delta image 130, second delta image 140, and differential image 150 may be detected in the phase enhanced image.

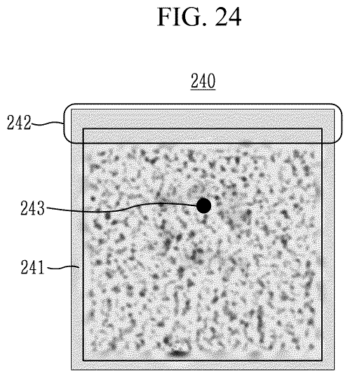

FIG. 24 is a view showing a phase enhanced image 240 created by subtracting a second phase image from a first phase image.

Referring to FIG. 24, the phase enhanced image 240 may include a padding region 241, a masking region 242, and a defective signal region 243. In the step (S441), the padding region 241 generated by performing the zero padding on the edges of the defect images (50, 60, 70, 80, and 90 of FIG. 5 to FIG. 9) and the masking region 242 that masks the noise in the defect images 50, 60, 70, 80, and 90 may be maintained without being removed in the step (S4443). The defective signal region 243 may include noise signals caused by defects such as the top loss. The noise signals may have different spectrum characteristics than normal signals.

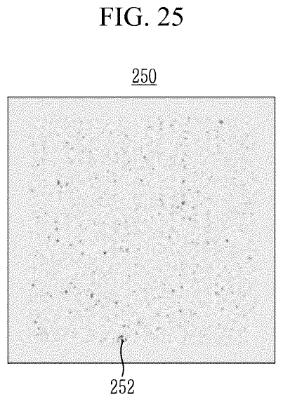

FIG. 25 to FIG. 28 are views showing a phase enhanced image 250, 260, 270 and 280, respectively, generated based on a phase enhanced algorithm.

FIG. 25 is the phase enhanced image 250 generated by performing an optimization process of the phase value by 20 times in the phase enhanced algorithm.

Referring to FIG. 25, in the phase enhanced image 250, in which the optimization process of the phase value was performed 20 times, the defective signal may be not detected. Also, the burn mark 252 may be very faint and difficult to be recognized. In this case, an additional optimization process of the phase value using the phase enhanced algorithm may be required.

Again referring to FIG. 16, in the step (S445), the defect detection device 100 may perform the optimization process of the phase value using the phase enhanced algorithm until the defective signal of the die (31 of FIG. 3) is detected.

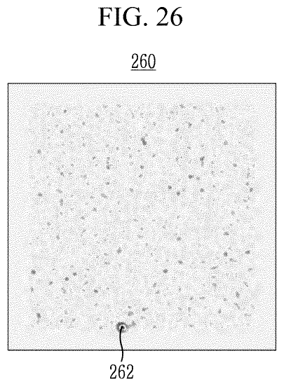

FIG. 26 is the phase enhanced image 260 generated by performing the optimization process of the phase value 50 times in the phase enhanced algorithm.

Referring to FIG. 26, even in the phase enhanced image 260 where the optimization process of the phase value was performed 50 times, the defective signal may not be detected. Also, the burn mark 262 may be very faint and difficult to be recognized. In this case, an additional optimization process of the phase value using the phase enhanced algorithm may be required.

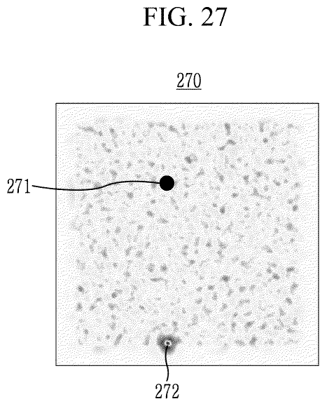

FIG. 27 is the phase enhanced image 270 generated by performing the phase value optimization process 150 times in the phase enhanced algorithm.

Referring to FIG. 27, a defective signal 271 may be detected in the phase enhanced image 270 in which the optimization process of the phase value was performed 150 times. Additionally, a burn mark 272 may also be detected to identify the defective signal 271.

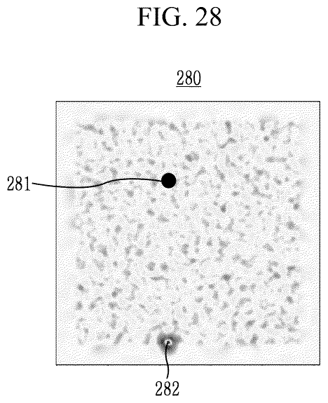

FIG. 28 is the phase enhanced image 280 generated by performing the phase value optimization process 200 times in the phase enhanced algorithm.

Referring to FIG. 28, a defective signal 281 may be detected in the phase enhanced image 280 in which the optimization process of the phase value was performed 200 times. Additionally, a burn mark 282 may also be detected to identify the defective signal 281.

When the initial value of the parameter W starts from 0, the defective signal (271 in FIG. 27, 281 in FIG. 28) may be detected after about 150 to 200 times of the optimization process using the phase enhanced algorithm.

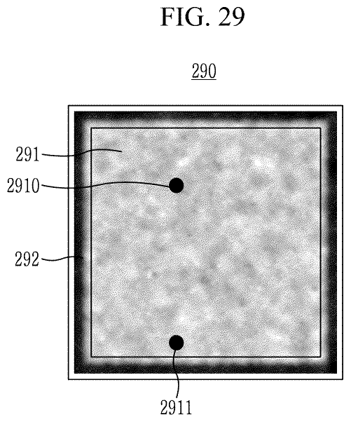

FIG. 29 to FIG. 31 are views showing phase enhanced images 290, 300 and 310, respectively, generated based on a phase enhanced algorithm according to a comparative example. At this time, the initial value of the parameter W of the phase enhanced images of FIG. 29 to FIG. 31 may have a random value other than 0. If the initial value of the parameter W is a random value, the optimization process of the parameter W according to the phase enhanced algorithm may take more time than when the initial value of the parameter W is 0. Since the initial value of the parameter W is a random value, B, the weight value of |BS−0| and γ, the weight value of ∂|BS−0| of the Neumann boundary condition, may not be 0. That is, the parameter W may be optimized based on Equation 1 of the phase enhanced algorithm, including |∂BS−0|*β+|BS−0|*γ. Accordingly, if the initial value of the parameter W is a random value, the convergence speed of the parameter W value may be slower than when the initial value of the parameter W is 0.

FIG. 29 is the phase enhanced image 290 generated by performing the optimization process of the phase value 10,000 times in the phase enhanced algorithm according to a comparative example.

Referring to FIG. 29, the phase enhanced image 290, in which the optimization process of the phase value is performed 10,000 times, may include a convergence region 291 and a boundary region 292. The boundary region 292 may be placed at a certain interval from the edge of the convergence region 291. A defective signal 2910 may be detected in the convergence region 291. Additionally, a burn mark 2911 may also be detected to identify the defective signal 2910.

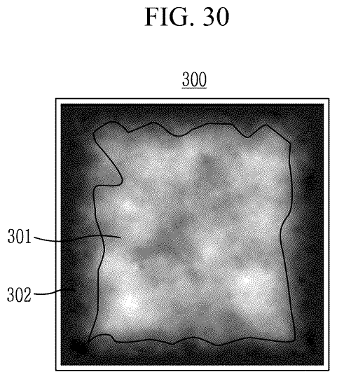

FIG. 30 is the phase enhanced image 300 generated by performing the optimization process of the phase value 20,000 times in the phase enhanced algorithm according to a comparative example.

Referring to FIG. 30, the phase enhanced image 300, in which the optimization process of the phase value was performed 20,000 times, may include a convergence region 301 and a boundary region 302. Compared with FIG. 29, the boundary region 302 of FIG. 30 may penetrate into the interior of the convergence region 301, thereby hindering the convergence of the phase enhanced image 300. This is because the Neumann boundary condition is not removed in the phase enhanced algorithm. If the value BS, which is the edge value of the phase enhanced image 300, is 0, then ∂BS, which is the change rate of the edge value of the phase enhanced image 300, may also remain 0. Also, if ∂BS, which is the change rate of the value of the edge of the phase enhanced image 300, remains at 0, the value BS, 0, may penetrate from the edge of the phase enhanced image 300 to the internal convergence region 301. Therefore, as the optimization process of the phase value is repeated, the convergence region 301 of the phase enhanced image 300 may not converge. Additionally, the defective signal may not be detected in the convergence region 301.

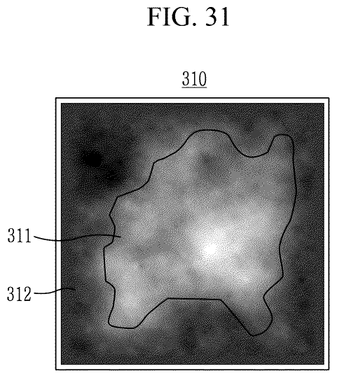

FIG. 31 is the phase enhanced image 310 generated by performing the optimization process of the phase value 30,000 times in the phase enhanced algorithm according to the comparative example.

Referring to FIG. 31, the phase enhanced image 310, in which the optimization process of the phase value is performed 30,000 times, may include a convergence region 311 and a boundary region 312. Compared with FIG. 30, the boundary region 312 of FIG. 31 may penetrate further into the interior of the convergence region 311, which may hinder the convergence of the phase enhanced image 310. As the optimization process of the phase value is repeated, the convergence region 311 of the phase enhanced image 310 may not converge. Additionally, the defective signal may not be detected in the convergence region 311.

Again, referring to FIG. 4, if, in step S440, the defective signal is not detected in the phase enhanced image generated by the defect detection device 100, the defect detection device 100, in step S410, may reset at least one of the pixel size, wavelength, aperture, polarization, and scan speed included in the configuration settings. Also, based on the reset configuration settings, the defect detection device 100 may control the camera 6 and the light source 7 to capture the images of the die 31 (see FIGS. 1 and 3).

Again, with reference to FIG. 4, if, in step S440, the defective signal is detected in the phase enhanced image generated by the defect detection device 100, the defect detection device 100, in step S450, may maintain the configuration settings. The defect detection device 100 may maintain the configuration settings based on the pixel size, wavelength, aperture, polarization, and scan speed set in step S413. The configuration settings may include the parameters such as the pixel size, wavelength, aperture, polarization, and scan speed that the defect detection device 100 sets to detect the defects in the die (31 in FIG. 3).

In step S440, if the defective signal is not detected in the phase enhanced image generated by the defect detection device 100, in step S410, the defect detection device 100 may reset the pixel size, the wavelength, the aperture, the polarization, and the scan speed.

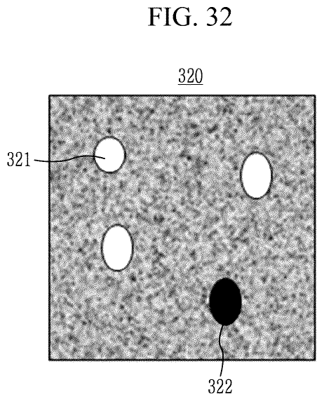

FIG. 32 to FIG. 34 are views showing images in which an electron beam inspection was performed to detect defects of a die after a pattern was formed on a wafer.

The electron beam inspection may be performed after a patterning process of the wafer (1 in FIG. 3) or after the dicing of the wafer 1 before a shipment. The electron beam inspection may accurately detect the defective signal of the die (31 in FIG. 3), but because the electron beam inspection requires a high precision, an inspection period may be relatively long. For example, it may take approximately 3-4 days to detect the defective signal in the die 31 using the electron beam inspection. On the other hand, if the defect detection device 100 is used, since the predetermined configuration settings are used and the defective signal of the die 31 is detected based on the difference between the phase images, the defective signal of the die 31may be detected within approximately 6 to 7 hours.

After the defective signal of the die 31 included in the wafer 1 was detected through the electron beam inspection, the burn marks 51, 61, 71, 81, and 91 for identifying the corresponding defective signals may be displayed on the defect images of the die 31 (50, 60, 70, 80, and 90 of FIG. 5 to FIG. 9). The defect detection device 100 may quickly detect the defect in the die 31 by using the phase enhanced algorithm described above for the defect images 50, 60, 70, 80, and 90 including the burn marks 51, 61, 71, 81, and 91.

FIG. 32 is an image of the first die 320 where the defective signal was detected via an electron beam.

The image of the first die 320 may include a normal region 321 and a defective region 322. The defective region 322 may include a region where noise signals are generated due to defective causes such as the top loss. The normal region 321 may include a region where a normal signal is generated, rather than a defective signal.

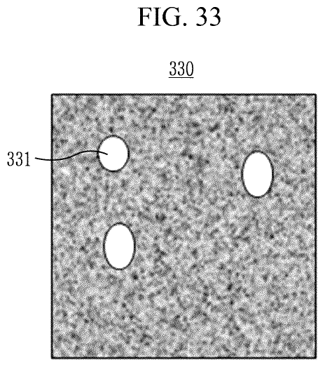

FIG. 33 is an image of the second die 330 in which no defective signal was detected through the electron beam.

The image of the second die 330 may be included on the same wafer (1 of FIG. 1) as the first die (shown in the image 320 of FIG. 32). Additionally, the second die shown in the image 330 may be adjacent to the first die shown in the image 320 of FIG. 32. The image of the second die 330 may include only the normal regions 331, excluding the defective region. The adjacent dies 31 (see FIG. 3) may have similar characteristics because they are manufactured according to a similar design and packaged in a similar manner. However, due to the nonuniformity of the manufacturing process and the influence of different thermal stresses, among other factors, the good die 31 and the defective die 31 may occur adjacent to each other. Accordingly, the first die shown in the image 320 of FIG. 32 may include the defective region (322 of FIG. 32) and the normal region (321 of FIG. 32), but the second die shown in the image 330 of FIG. 33 may include only the normal region 331 excluding the defective region.

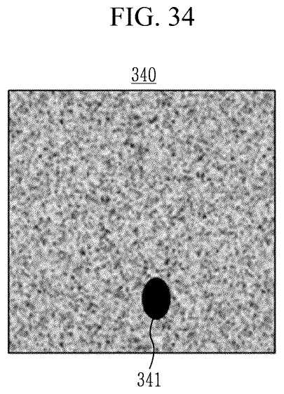

FIG. 34 is a comparison image 340 showing the difference between the image of the defective die (e.g., image 320 of FIG. 32) and the image of the normal die (e.g., image 330 of FIG. 33).

Referring to FIG. 32 to FIG. 34, the comparison image 340 is an image obtained by subtracting the image of the second die (330 in FIG. 33), which is the normal die, from the image of the first die (320 in FIG. 32), which is the defective die. The comparison image 340 may include only the defective region 341. It may take approximately 30-40 days to detect the defective signal in the die 31 using the electron beam inspection.

In the defect images (50, 60, 70, 80, and 90 of FIG. 5 to FIG. 9) of the die 31 generated by the defect detection device 100, the burn marks (51, 61, 71, 81, and 91 of FIG. 5 to FIG. 9) for identifying the defective regions may be displayed by a scanning electron microscope (SEM). The defect detection device 100 may detect the defective regions through the phase enhanced algorithm described above.

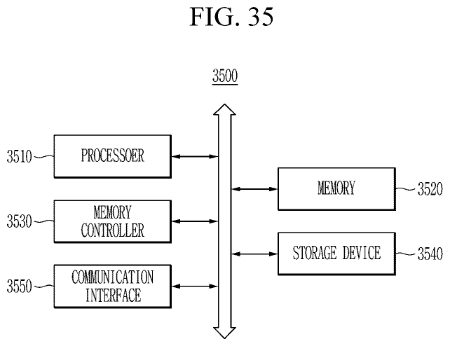

FIG. 35 is an example block diagram showing a computer device according to an embodiment of the inventive concept.

Referring to FIG. 35, a compute device 3500 includes a processor 3510, a memory 3520, a memory controller 3530, a storage device 3540, and a communication interface 3550. The compute device 3500 may further include other general-purpose components. The processor 3510, the memory 3520, the memory controller 3530, the storage device 3540, and the communication interface 3550 may be interconnected with each other via an internal bus 3560.

The processor 3510 controls the overall operation of each component of the computing device 3500. The processor 3510 may be implemented with at least one of various processing units, such as a calculation circuit (a central processing unit), an application processor (AP), or a graphic processing unit (GPU), although embodiments are not limited thereto.

The processor 3510 may perform the zero padding on the defect images (50, 60, 70, 80, and 90 of FIG. 5 to FIG. 9) or the reference image. The processor 3510 may convert the defect images 50, 60, 70, 80, and 90 and the reference image into the phase images using the phase enhanced algorithm.

The processor 3510 may generate the first phase image (220 in FIG. 22) by subtracting two defect phase images with the different focus offsets. The processor 3510 may generate the second phase image (230 in FIG. 23) by subtracting two reference phase images with the different focus offsets. The processor 3510 may generate the phase enhanced image (240 in FIG. 24) by subtracting the second phase image 230 from the first phase image 220.

The processor 3510 may set the initial value of the parameter W of the phase enhanced image 240 to 0. The processor 3510 may detect the defective signal (243 of FIG. 24) of the die (31 of FIG. 3) based on the phase enhanced image 240.

The memory 3520 stores various data and instructions. The memory 3520 may be implemented as a memory device as described with reference to FIG. 1 to FIG. 17. The memory controller 3530 controls the transfer of the data or instructions to and from the memory 3520. In some embodiments, the memory controller 3530 may be provided as a separate chip from the processor 3510. In some embodiments, the memory controller 3530 may be provided as an internal component of the processor 3510.

The storage device 3540 stores programs and data non-temporarily. In some embodiments, the storage device 3540 may be implemented as a non-volatile memory. The communication interface 3550 supports wired and wireless Internet communication of the compute device 3500. Additionally, the communication interface 3550 may support various communication methods other than an Internet communication.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A defect detection method for detecting a presence of a defect in at least one semiconductor die, the method comprising:
performing a zero padding on a defect image and a reference image having a same focus offset as the defect image;
converting the defect image and the reference image into a defect phase image and a reference phase image, respectively, using a phase enhanced algorithm;
generating a phase enhanced image based on the defect phase image and the reference phase image;
detecting a defective signal indicative of a defect in a first semiconductor die from the phase enhanced image; and
controlling a camera to capture a second image of a second semiconductor die if the defective signal indicative of a defect in the first semiconductor die is detected in the phase enhanced image.

2. The defect detection method of claim 1, wherein:
converting the defect image and the reference image into the defect phase image and the reference phase image, respectively, using the phase enhanced algorithm includes:
setting an initial value of a phase value of the phase enhanced algorithm; and
converting the defect image and the reference image into the defect phase image and the reference phase image, respectively, using the phase enhanced algorithm, in which a convergence speed of the phase value is accelerated according to the setting of the initial value,
generating the phase enhanced image based on the defect phase image and the reference phase image includes
generating an optimized phase enhanced image based on the defect phase image and the reference phase image generated as the initial value of the phase value of the phase enhanced algorithm is set, and
detecting a defective signal from the phase enhanced image includes
detecting a defective signal from the optimized phase enhanced image.

3. The defect detection method of claim 2, wherein:
converting the defect image and the reference image into the defect phase image and the reference phase image, respectively, includes:
generating the defect phase image through the phase enhanced algorithm based on a difference between a first defect image having a first focus offset and a second defect image having a second focus offset different from the first focus offset; and
generating the reference phase image through the phase enhanced algorithm based on the difference between the first reference image with the first focus offset and the second reference image with the second focus offset.

4. The defect detection method of claim 2, wherein:
generating the optimized phase enhanced image based on the defect phase image and the reference phase image includes:
generating the optimized phase enhanced image by subtracting the defect phase image from the reference phase image.

5. The defect detection method of claim 2, wherein:
the phase enhanced algorithm comprises an algorithm configured to determine a phase value for which the following Equation 1 becomes a minimum:
W=argmin[|Δlz+Δ_{⊥}W|*α+|∂BS−0|*β+|BS−0|*γ] (Equation 1)
wherein, W is a phase value, Δlz is a difference value between defect images with different focus offsets or a difference value between reference images with different focus offsets, Δ_{⊥}W is a curvature of a phase change in a horizontal direction and a vertical direction of the defect phase image or a curvature of the phase change in the horizontal direction and the vertical direction of the reference phase image, ∂BS is a change rate of an edge value of the defect phase image or the reference phase image, BS is the edge value of the defect phase image or the reference phase image, α is a weight value of |Δlz+Δ_{⊥}W|, β is a weight value of |∂BS−0|, and γ is a weight value of |BS−0|.

6. The defect detection method of claim 5, wherein:
performing the zero padding on the defect image and the reference image having the same focus offset as the defect image includes:
setting pixel values of an edge region of each of the defect image and the reference image to 0.

7. The defect detection method of claim 6, further comprising:
masking a noise region distributed within each of the defect image and the reference image.

8. The defect detection method of claim 6, wherein:
when converting the defect image and the reference image, in which the pixel value of the edge region is set to 0, into the defect phase image and the reference phase image, respectively, the weight value β of |∂BS−0| and the weight value γ of |BS−0| in Equation 1 are set to 0.

9. The defect detection method of claim 8, wherein:
setting the initial value of the phase value of the phase enhanced algorithm includes:
setting the initial value of the phase value of the phase enhanced algorithm to 0; and
determining the phase value at which [|Δlz+Δ_{⊥}W|*α] becomes a minimum in Equation 1 of the phase enhanced algorithm.

10. The defect detection method of claim 1, wherein:
detecting the defective signal from the phase enhanced image includes:
detecting the defective signal through a burn mark positioned away from a defective region where the defective signal exists in the phase enhanced image.

11. A defect detection device, comprising:
a light source configured to illuminate a wafer including a plurality of dies;
a camera configured to capture a first image of at least one die of the plurality of dies; and
an electronic device configured:
to provide configuration settings that include at least one of a pixel size, a wavelength, an aperture, a polarization, or a scan speed;
to control the camera and the light source to capture the first image of the at least one die based on the configuration settings;
to receive information about a defect image and a reference image of the at least one die from the camera;
to convert the defect image and the reference image into a defect phase image and a reference phase image, respectively, through a phase enhanced algorithm;
to generate a phase enhanced image based on the defect phase image and the reference phase image; and
to control the camera and the light source to capture a second image of another one of the plurality of dies based on the configuration settings if a defective signal indicative of a defect in the at least one die is detected in the phase enhanced image.

12. The defect detection device of claim 11, wherein:
the electronic device is further configured:
to receive, from the camera, information about a first defect image with a first focus offset, a second defect image with a second focus offset different from the first focus offset, a first reference image with the first focus offset, a second reference image with the second focus offset;
to generate a defect phase image through the phase enhanced algorithm based on a difference between the first defect image and the second defect image; and
to generate a reference phase image through the phase enhanced algorithm based on a difference between the first reference image and the second reference image.

13. The defect detection device of claim 12, wherein:
the electronic device is further configured to generate the phase enhanced image by subtracting the defect phase image from the reference phase image.

14. The defect detection device of claim 11, wherein:
the electronic device is further configured to reset at least one of the pixel size, the wavelength, the aperture, the polarization, or the scan speed included in the configuration settings if a defective signal within the die is not detected in the phase enhanced image and to control the camera and the light source to capture images of the at least one die based on the reset configuration settings.

15. A defect detection device for detecting a defect in a die, comprising:
a storage device configured to store a defect image and a reference image;
an electronic device configured to perform a zero padding on the defect image and the reference image that has a same focus offset as the defect image, and to convert the defect image and the reference image into a defect phase image and a reference phase image, respectively, using a phase enhanced algorithm; and
a camera configured to capture images of the die by adjusting a focus offset of a lens responsive to one or more operations of the electronic device.

16. The defect detection device of claim 15, wherein:
the electronic device is further configured to perform the zero padding on the defect image and the reference image having the same focus offset as the defect image by setting pixel values of an edge region of each of the defect image and the reference image to 0.

17. The defect detection device of claim 16, wherein:
the phase enhanced algorithm comprises an algorithm configured to determine a phase value for which the following Equation 1 becomes a minimum:
W=argmin[|Δlz+Δ_{⊥}W|*α+|∂BS−0|*β+|BS−0|*γ] (Equation 1)
wherein, W is a phase value, Δlz is a difference value between defect images with different focus offsets or a difference value between reference images with different focus offsets, Δ_{⊥}W is a curvature of a phase change in a horizontal direction and a vertical direction of the defect phase image or the curvature of the phase change in the horizontal direction and the vertical direction of the reference phase image, ∂BS is a change rate of an edge value of the defect phase image or the reference phase image, BS is the edge value of the defect phase image or the reference phase image, a is a weight value of |Δlz+Δ_{⊥}W|, β is a weight value of |∂BS−0|, and γ is a weight value of |BS−0|.

18. The defect detection device of claim 17, wherein:
the electronic device is further configured to set an initial value of the phase value of the phase enhanced algorithm to 0, and to convert the defect image and the reference image into the defect phase image and the reference phase image, respectively, through the phase enhanced algorithm.

19. The defect detection device of claim 18, wherein:
the electronic device is further configured to convert the defect image and the reference image into the defect phase image and the reference phase image, respectively, through the phase value where [|Δlz Δ_{⊥}W|*α] becomes the minimum in Equation 1 of the phase enhanced algorithm.

20. The defect detection device of claim 19, wherein:
the electronic device is further configured to generate an optimized phase enhanced image by subtracting the reference phase image from the defect phase image, and to detect a defective signal based on the optimized phase enhanced image, the defective signal indicative of the defect in the die.
